(19) United States
(12) Patent Application Publication
(10) Pub. No.: US 2014/0204605 A1
(43) Pub. Date: Jul. 24, 2014

(54) LIGHT-IMPORTING SYSTEM, DIRECT-LIT BACKLIGHT MODULE AND LIQUID CRYSTAL DISPLAY DEVICE

(71) Applicants: Che-chang Hu, Shenzhen City (CN); Hu He, Shenzhen City (CN)

(72) Inventors: Che-chang Hu, Shenzhen City (CN); Hu He, Shenzhen City (CN)

(73) Assignee: Shenzhen China Star Optoelectronics Technology Co. Ltd., Shenzhen, Guangdong (CN)

(21) Appl. No.: 13/818,754

(22) PCT Filed: Jan. 28, 2013
(86) PCT No.: PCT/CN13/71012

§ 371 Date: Feb. 25, 2013

(30) Foreign Application Priority Data
Jan. 22, 2013 (CN) 201310027256.7

(51) Int. Cl. G02F 1/1335

(52) U.S. Cl. CPC G02F 1/133606
USPC 362/558; 362/97.1; 362/97.2

(57) ABSTRACT

The present invention provides a light-importing system, direct-lit backlight module and liquid crystal display device. The light-importing system includes ambient light collection system, facing and collecting ambient light, and outputting absorbed light; a plurality of light-guiding devices, each having light-entering end and light-exiting end, light-entering end adjacent to ambient light collection system, the absorbed light entering light-entering end and guided to light-exiting end, the plurality of the light-exiting ends being arranged in an array format underneath a light-entering surface of a diffuser; and a plurality of light diffusion devices, each disposed between light-exiting end and light-entering surface, expanding the light-emitting angle of the light-exiting end. Because of light diffusion device disposed between light-exiting end and light-entering surface expanding light-emitting angle of light-exiting end, the phenomenon of uneven luminance between light-exiting ends is improved, leading to improvement of displaying quality of direct-lit backlight module.

### BACKGROUND OF THE INVENTION

1. Field of the Invention

The present invention relates to the field of liquid crystal displaying techniques, and in particular to a light-importing system, direct-lit backlight module and liquid crystal display device.

2. The Related Arts

Recently, the backlight module of the liquid crystal display device uses mostly original light source as the backlight source. The original light source means the light source using electricity to emit light, such as, LED, and CCFL. The LED has the advantage of high energy efficiency, and is widely used as the backlight source in backlight modules. However, as the demands on even higher efficiency in energy consumption grow, the number of original light sources in the backlight module must be reduced to meet such a high standard. Alternatively, a new type of energy-saving light source must be developed as the backlight module to meet the demands.

By using the ambient light, such as, sun light, as the backlight source in the backlight module is a new energy-saving approach. In this approach, the original light source relying on electricity is reduced or even eliminated to save the energy consumption. At present, a possibly feasible approach is to collect the ambient light and use a plurality of optical fibers to output the collected ambient light to the backlight module to serve as the backlight source of the backlight module. However, because the light-emitting angle at the light-exiting end is smaller, the luminance difference between the light-exit end and the front of the light-exiting end (i.e., between left and right of the light-exiting end) is large, which leads to distinct luminance difference. An even more severe case would show the distinct locations of each light-exiting end, which results in deterioration of the displaying quality.

### SUMMARY OF THE INVENTION

The present invention provides a light-importing system, applicable to direct-lit backlight module, which comprises: an ambient light collection system, configured to face the ambient light to absorb the ambient light and output the absorbed light; a plurality of light-guiding devices, each having a light-entering end and a light-exiting end, the light-entering end being adjacent to the ambient light collection system, the absorbed light entering the light-entering end and being guided to the light-exiting end, the plurality of the light-exiting ends being arranged in an array format underneath a light-entering surface of a diffuser; and a plurality of light diffusion devices, each disposed between the light-exiting end and the light-entering surface, configured to expand the light-emitting angle of the light-exiting end.

The present invention provides a direct-lit backlight module, which comprises: a backplane, a reflector, a diffuser and an optical film; wherein the diffuser having a light-entering surface and a light-exiting surface, disposed oppositely; the reflector being disposed underneath the light-entering surface, the backplane being disposed underneath the reflector; the optical film being disposed above the light-exiting surface; wherein the direct-lit backlight module further comprising a light-importing system, the light-importing system, comprising: an ambient light collection system, configured to face the ambient light to absorb the ambient light and output the absorbed light; a plurality of light-guiding devices, each having a light-entering end and a light-exiting end, the light-entering end being adjacent to the ambient light collection system, the absorbed light entering the light-entering end and being guided to the light-exiting end, the plurality of the light-exiting ends being arranged in an array format underneath a light-entering surface of a diffuser; and a plurality of light diffusion devices, each disposed between the light-exiting end and the light-entering surface, configured to expand the light-emitting angle of the light-exiting end.

The present invention provides a liquid crystal display device, which comprises: which comprises: a backplane, a reflector, a diffuser, an optical film and a display panel; wherein the diffuser having a light-entering surface and a light-exiting surface, disposed oppositely; the reflector being disposed underneath the light-entering surface, the backplane being disposed underneath the reflector; the optical film being disposed above the light-exiting surface; the display panel being disposed above the optical film; wherein the liquid crystal display device further comprising a light-importing system, the light-importing system, comprising: an ambient light collection system, configured to face the ambient light to absorb the ambient light and output the absorbed light; a plurality of light-guiding devices, each having a light-entering end and a light-exiting end, the light-entering end being adjacent to the ambient light collection system, the absorbed light entering the light-entering end and being guided to the light-exiting end, the plurality of the light-exiting ends being arranged in an array format underneath a light-entering surface of a diffuser; and a plurality of light diffusion devices, each disposed between the light-exiting end and the light-entering surface, configured to expand the light-emitting angle of the light-exiting end.

According to a preferred embodiment of the present invention, the light-guiding device is optical fiber.

According to a preferred embodiment of the present invention, the light diffusion device is a biconcave lens or a plano-concave lens.

According to a preferred embodiment of the present invention, the light-exiting end is corresponding to the center of the light diffusion device, and the light diffusion device has a width meeting the following condition: W<P, wherein W is the width of the light diffusion device and P is the distance between two adjacent light-exiting ends.

According to a preferred embodiment of the present invention, the light-importing system further comprises a plurality of original light sources, and the plurality of original light sources and the plurality light-exiting ends are arranged interleavingly in an array format.

According to a preferred embodiment of the present invention, the original light source is an LED.

According to a preferred embodiment of the present invention, the light-exiting end is corresponding to the center of the light diffusion device, and the light diffusion device has a width meeting the following condition: W<P₂−L and W<P₁−L, wherein W is the width of the light diffusion device, P₁ is the distance between two adjacent light-exiting ends, P₂ is the distance between two adjacent original light sources and L is the width of the original light source.

The efficacy of the present invention is that to be distinguished from the state of the art. According to the light-importing system, direct-lit backlight module and the liquid crystal display device of the present invention, the light-importing system imports the ambient light into the direct-lit backlight module to serve as the backlight source of the backlight module to reduce or eliminate the use of the original light source and save energy consumption. In addition, because of the light diffusion device disposed between the light-exiting end and the light-entering surface to expand the light-emitting angle of the light-exiting end, the phenomenon of uneven luminance between the light-exiting ends is improved, leading to improvement of displaying quality of direct-lit backlight module.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a schematic view showing the structure of a direct-lit backlight module of the first embodiment of the present invention;

FIG. 2 is a schematic view showing the biconcave lens expanding the light-emitting angle of the light-exiting end in the first embodiment of the present invention;

FIG. 3 is a schematic view showing the plano-concave lens expanding the light-emitting angle of the light-exiting end in the first embodiment of the present invention;

FIG. 4 is a schematic view showing another disposition of the plano-concave lens of the first embodiment of the present invention;

FIG. 5 a schematic view showing the structure of a direct-lit backlight module of the second embodiment of the present invention; and

FIG. 6 is a schematic view showing the liquid crystal display device of the first embodiment or the second embodiment of the present invention.

### DETAILED DESCRIPTION OF THE PREFERRED EMBODIMENTS

For description of the technical means and result of the present invention, the following refers to the drawings and embodiments for detailed description, wherein the same number indicates the same part.

### The First Embodiment

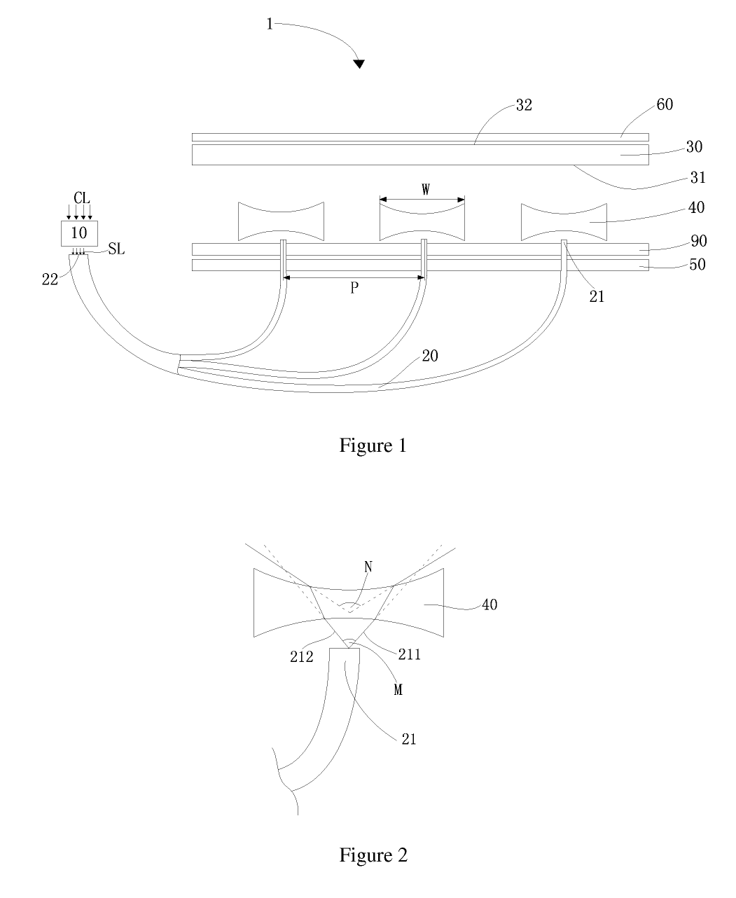

Referring to FIG. 1, the direct-lit backlight module 1 comprises: an ambient light collection system 10, a plurality of optical fibers 20, a plurality of biconcave lenses 40, a backplane 50, a diffuser 30, an optical film 60 and a reflector 90; wherein the diffuser 30 comprises a light-entering surface 31 and a light-exiting surface 32, disposed oppositely; the reflector 90 is disposed underneath the light-entering surface 31, the backplane is disposed underneath the reflector 90, and the optical film 60 is disposed above the light-exiting surface 32.

In the instant embodiment, the ambient light collection system 10, the plurality of optical fibers 20 and the plurality of biconcave lenses 40 form a light-importing system, wherein each optical fiber has a light-exiting end 21 and a light-entering end 22. The light-entering ends 22 of the plurality of optical fibers 20 are bundled together and placed adjacent to the ambient light collection system 10. The light-exiting ends 21 of optical fibers 20 are arranged in an array format above the reflector 90. In other words, the light-exiting ends 21 of optical fibers 20 are arranged in an array format underneath the light-entering surface 31. Each biconcave lens 40 is disposed correspondingly between the light-exiting end 21 of the optical fiber 20 and the light-entering surface 31.

The ambient light collection system 10 faces the ambient light CL to absorb the ambient light CL and transform the ambient light CL into absorbed light SL to output. The ambient light CL can be sun light, lamp light or light from any light-emitting objects. The wavelength of the absorbed light SL is within the range of the visible light. In other words, the absorbed light SL can be used as backlight source for the backlight module. The absorbed light SL passes the light-entering end 22 to enter the optical fiber 20 and is propagated to the light-exiting end 21. The light exiting the light-exiting end 21 passes the biconcave lens 40 and the light-entering surface 31 to enter the diffuser 30. The diffuser 30 diffuses the entering light and the diffused light is emitted from the light-exiting surface 32. In the instant embodiment, the optical fiber 20 is a preferred light-guiding device, and the loss in the optical fiber 20 is very low to ensure sufficient light reaching the light-exiting end 21. As a light diffusion device, the biconcave lens 40 can expand the light-emitting angle of the light-exiting end.

In the instant embodiment, for the light-emitting angle of the light-exiting end to be expanded to an maximum, the light-exiting end 21 is preferably disposed correspondingly to the center of the biconcave lens 40 and maintains a suitable distance from the biconcave lens 40. The light emitted from the light-exiting end 21 passes the biconcave lens 40 to reach the light-entering surface. To minimize the uneven luminance phenomenon of the light-entering surface, the width of the biconcave lens 40 must satisfy the following equation (1):

W<P (1)
wherein W is the width of the biconcave lens 40, and P is the distance between two adjacent light-exiting ends.

The following describes the theory behind the biconcave lens 40 expanding the light-emitting angle of the light-exiting end in details.

Also referring to FIG. 2, for any two rays 211, 212 of the light emitted from the light-exiting end 21, assume that the biconcave lens 40 is not disposed between the light-exiting end 21 and light-entering surface 31. The rays 211, 212 will travel along a straight line, i.e., the dash line in the figure, to form a light-emitting angle of M. However, as the biconcave lens 40 is disposed between the light-exiting end 21 and light-entering surface 31 in the present embodiment, the refraction occurs the interface between any concave surface of the biconcave lens 40 and the air for rays 211, 212. This is caused by the refraction index of the biconcave lens 40 greater than the refraction index of the air, i.e., the rays 211, 212 will travel along the solid line in the figure. The dash line extending from the reverse direction of the solid line of the biconcave lens 40 forms a light-emitting angle of N. As shown, the light-emitting angle N is greater than the light-emitting angle M. Similarly, any other rays emitted from the light-exiting end 21 follows the same theory so that the light emitted from the light-exiting end 21 after the biconcave lens 40 is expanded.

A plano-concave lens 41 can also be used to replace the biconcave lens 40. The theory behind the plano-concave lens 41 expanding the light-emitting angle of the light-exiting end 21 is described as follows.

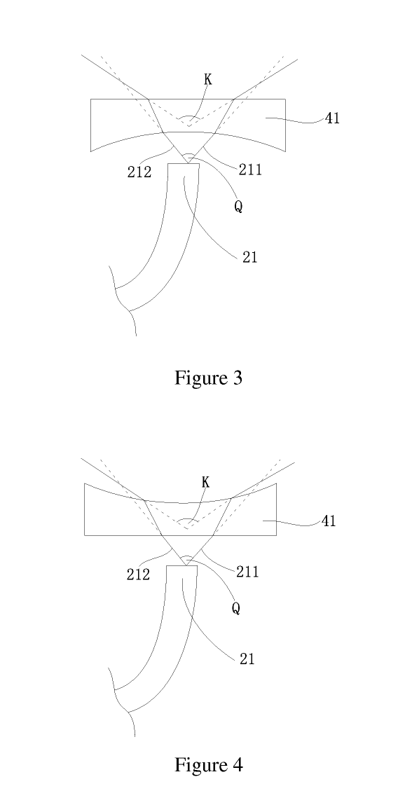

Referring to FIG. 3, the concave surface of the plane-concave lens 41 is corresponding to the light-exiting end 21. For any two rays 211, 212 of the light emitted from the light-exiting end 21, assume that the plano-concave lens 41 is not disposed between the light-exiting end 21 and light-entering surface 31. The rays 211, 212 will travel along a straight line, i.e., the dash line in the figure, to form a light-emitting angle of Q. However, as the plano-concave lens 41 is disposed between the light-exiting end 21 and light-entering surface 31 in the present embodiment, the refraction occurs the interface between the concave surface or the planar surface of the plano-concave lens 41 and the air for rays 211, 212. This is caused by the refraction index of the plano-concave lens 41 greater than the refraction index of the air, i.e., the rays 211, 212 will travel along the solid line in the figure. The dash line extending from the reverse direction of the solid line of the plano-concave lens 41 forms a light-emitting angle of K. As shown, the light-emitting angle K is greater than the light-emitting angle Q. Similarly, any other rays emitted from the light-exiting end 21 follows the same theory so that the light emitted from the light-exiting end 21 after the plano-concave lens 41 is expanded.

Referring to FIG. 4, the planar surface of the plano-concave lens 41 can also be corresponding to the light-exiting end 21. The rays 211, 212 will be refracted first at the interface between the air and the planar surface of the plano-concave lens 41 and then refracted again at the interface between the air and the concave surface of the plano-concave lens 41. As shown, the light-emitting angle K is greater than the light-emitting angle Q, and the light emitted from the light-exiting end 21 after the plano-concave lens 41 is expanded.

### The Second Embodiment

The part of the description of the second embodiment that is identical to the description of the first embodiment will not be repeated here. The following only describes different part.

LED is often used as an original light source of the backlight module. Other original light sources include fluorescent light, CCFL or other light-emitting objects with electricity as power.

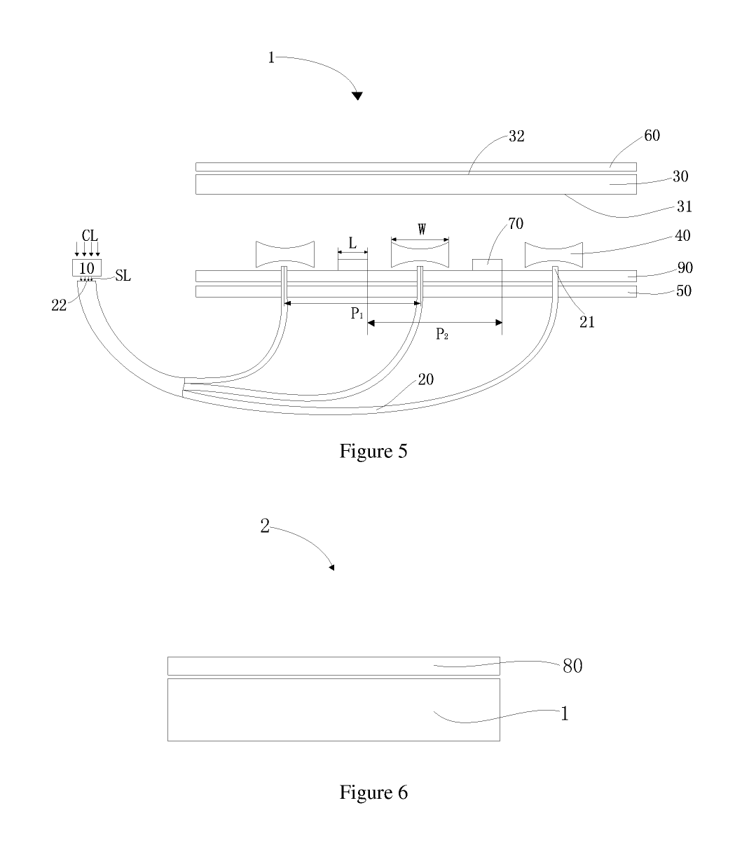

Referring to FIG. 5, the direct-lit backlight module 1 can further comprise a plurality of LEDs 70. The LEDs 70 and the light-exiting ends 21 are arranged interleavingly in an array format above the reflector 90. That is, the LEDs 70 and the light-exiting ends 21 are arranged interleavingly in an array format underneath the light-entering surface 31. The biconcave lens 40 is disposed between the light-exiting end 21 and the light-entering surface 31. Alternatively, the plano-concave lens 41 can be used instead of biconcave lens 40. With such structure, the LED 70 and the light-exiting ends 21 are used as the backlight source to reduce the number of LEDs used. In the present embodiment, the ambient light collection system 10, the plurality of optical fibers 20, the plurality of LEDs 70 and the plurality of biconcave lens 40 form the light-importing system.

It should be noted that in the instant embodiment, for the light-emitting angle of the light-exiting end to be expanded to an maximum, the light-exiting end 21 is preferably disposed correspondingly to the center of the biconcave lens 40 and maintains a suitable distance from the biconcave lens 40. The light emitted from the light-exiting end 21 passes the biconcave lens 40 to reach the light-entering surface. To minimize the uneven luminance phenomenon of the light-entering surface, the width of the biconcave lens 40 must satisfy the following equation (2):

W<P₂−L and W<P₁−L (2)
wherein W is the width of the biconcave lens 40, P₁ is the distance between two adjacent light-exiting ends, P₂ is the distance between two adjacent LEDs 70 and L is the width of the LED 70.

The direct-lit backlight module of the first or second embodiment is applicable to liquid crystal display device. The following describes a liquid crystal display device using the direct-lit backlight module of the first or second embodiment.

Referring to FIG. 6, a display panel 80 is disposed on the direct-lit backlight module 1 to form a complete liquid crystal display device 2. The direct-lit backlight module 1 provides uniformly distributed light source to the display panel 80 so that the display panel 80 has sufficient luminance to display images.

In summary, the light-importing system imports the ambient light into the direct-lit backlight module to serve as backlight source to reduce or eliminate the use of original light source and save energy. In addition, the disposition of the biconcave lens or the plano-concave lens between the light-exiting end and the light-entering surface to expand the light-emitting angle will improve the uneven luminance phenomenon between light-exiting ends and improve the displaying quality of the direct-lit backlight module.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

What is claimed is:

1. A light-importing system, applicable to direct-lit backlight module, which comprises:
an ambient light collection system, configured to face the ambient light to absorb the ambient light and output the absorbed light;
a plurality of light-guiding devices, each having a light-entering end and a light-exiting end, the light-entering end being adjacent to the ambient light collection system, the absorbed light entering the light-entering end and being guided to the light-exiting end, the plurality of the light-exiting ends being arranged in an array format underneath a light-entering surface of a diffuser; and
a plurality of light diffusion devices, each disposed between the light-exiting end and the light-entering surface, configured to expand the light-emitting angle of the light-exiting end.

2. The light-importing system as claimed in claim 1, wherein the light-guiding device is optical fiber.

3. The light-importing system as claimed in claim 1, wherein the light diffusion device is a biconcave lens.

4. The light-importing system as claimed in claim 1, wherein the light diffusion device is a plano-concave lens.

5. The light-importing system as claimed in claim 1, wherein the light-exiting end is corresponding to the center of the light diffusion device, and the light diffusion device has a width meeting the following condition:
W<P,
wherein W is the width of the light diffusion device and P is the distance between two adjacent light-exiting ends.

6. The light-importing system as claimed in claim 1, wherein the light-importing system further comprises a plurality of original light sources, and the plurality of original light sources and the plurality light-exiting ends are arranged interleavingly in an array format.

7. The light-importing system as claimed in claim 6, wherein the original light source is an LED.

8. The light-importing system as claimed in claim 6, wherein the light-exiting end is corresponding to the center of the light diffusion device, and the light diffusion device has a width meeting the following condition:
W<P₂−L and W<P₁−L,
wherein W is the width of the light diffusion device, P₁ is the distance between two adjacent light-exiting ends, P₂ is the distance between two adjacent original light sources and L is the width of the original light source.

9. A direct-lit backlight module, which comprises: a backplane, a reflector, a diffuser and an optical film; wherein the diffuser having a light-entering surface and a light-exiting surface, disposed oppositely; the reflector being disposed underneath the light-entering surface, the backplane being disposed underneath the reflector; the optical film being disposed above the light-exiting surface; wherein the direct-lit backlight module further comprising a light-importing system, the light-importing system comprising:
an ambient light collection system, configured to face the ambient light to absorb the ambient light and output the absorbed light;
a plurality of light-guiding devices, each having a light-entering end and a light-exiting end, the light-entering end being adjacent to the ambient light collection system, the absorbed light entering the light-entering end and being guided to the light-exiting end, the plurality of the light-exiting ends being arranged in an array format underneath a light-entering surface of a diffuser; and
a plurality of light diffusion devices, each disposed between the light-exiting end and the light-entering surface, configured to expand the light-emitting angle of the light-exiting end.

10. The direct-lit backlight module as claimed in claim 9, wherein the light-guiding device is optical fiber and the light diffusion device is a biconcave lens.

11. The direct-lit backlight module as claimed in claim 9, wherein the light-guiding device is optical fiber and the light diffusion device is a plano-concave lens.

12. The direct-lit backlight module as claimed in claim 9, wherein the light-exiting end is corresponding to the center of the light diffusion device, and the light diffusion device has a width meeting the following condition:
W<P,
wherein W is the width of the light diffusion device and P is the distance between two adjacent light-exiting ends.

13. The direct-lit backlight module as claimed in claim 9, wherein the light-importing system further comprises a plurality of original light sources, and the plurality of original light sources and the plurality light-exiting ends are arranged interleavingly in an array format.

14. The direct-lit backlight module as claimed in claim 13, wherein the light-exiting end is corresponding to the center of the light diffusion device, and the light diffusion device has a width meeting the following condition:
W<P₂−L and W<P₁−L,
wherein W is the width of the light diffusion device, P₁ is the distance between two adjacent light-exiting ends, P₂ is the distance between two adjacent original light sources and L is the width of the original light source.

15. A liquid crystal display device, which comprises: which comprises: a backplane, a reflector, a diffuser, an optical film and a display panel; wherein the diffuser having a light-entering surface and a light-exiting surface, disposed oppositely; the reflector being disposed underneath the light-entering surface, the backplane being disposed underneath the reflector; the optical film being disposed above the light-exiting surface; the display panel being disposed above the optical film; wherein the liquid crystal display device further comprising a light-importing system, the light-importing system comprising:
an ambient light collection system, configured to face the ambient light to absorb the ambient light and output the absorbed light;
a plurality of light-guiding devices, each having a light-entering end and a light-exiting end, the light-entering end being adjacent to the ambient light collection system, the absorbed light entering the light-entering end and being guided to the light-exiting end, the plurality of the light-exiting ends being arranged in an array format underneath a light-entering surface of a diffuser; and
a plurality of light diffusion devices, each disposed between the light-exiting end and the light-entering surface, configured to expand the light-emitting angle of the light-exiting end.

16. The liquid crystal display device as claimed in claim 15, wherein the light-guiding device is optical fiber and the light diffusion device is a biconcave lens.

17. The liquid crystal display device as claimed in claim 15, wherein the light-guiding device is optical fiber and the light diffusion device is a plano-concave lens.

18. The liquid crystal display device as claimed in claim 15, wherein the light-exiting end is corresponding to the center of the light diffusion device, and the light diffusion device has a width meeting the following condition:
W<P,
wherein W is the width of the light diffusion device and P is the distance between two adjacent light-exiting ends.

19. The liquid crystal display device as claimed in claim 15, wherein the light-importing system further comprises a plurality of original light sources, and the plurality of original light sources and the plurality light-exiting ends are arranged interleavingly in an array format.

20. The liquid crystal display device as claimed in claim 19, wherein the light-exiting end is corresponding to the center of the light diffusion device, and the light diffusion device has a width meeting the following condition:
W<P₂−L and W<P₁−L,
wherein W is the width of the light diffusion device, P₁ is the distance between two adjacent light-exiting ends, P₂ is the distance between two adjacent original light sources and L is the width of the original light source.
